(19) United States
(12) Patent Application Publication
(10) Pub. No.: US 2024/0017806 A1
(43) Pub. Date: Jan. 18, 2024

(54) CONNECTION INTERFACE FOR UNDERWATER APPLICATIONS

(71) Applicant: Scubajet Gmbh, Klagenfurt am Wörthersee (AT)

(72) Inventor: Armin KUNDIGRABER, Maria Rain (AT)

(21) Appl. No.: 17/754,693

(22) PCT Filed: Oct. 9, 2020
(86) PCT No.: PCT/EP2020/078404

§ 371 Date: Apr. 8, 2022

(30) Foreign Application Priority Data
Oct. 10, 2019 (EP) 19202568.2

(51) Int. Cl. B63C 11/26; B63C 11/46; H02J 50/10

(52) U.S. Cl. CPC B63C 11/26; B63C 11/46; H02J 50/10

(57) ABSTRACT

The application relates to a connection interface for underwater applications, in particular for water sport equipment, including a connection unit for transmitting data and having a charging coil for inductively transmitting energy to a similar connection interface, the connection unit being designed as an optical connection unit, in particular as an infrared connection unit, for transmitting and/or receiving an optical signal.

The invention relates to a connection interface for underwater applications, in particular for water sport equipment, comprising a connection unit for transmitting data and having a charging coil for inductively transmitting energy to a similar connection interface. The invention further relates to water sport equipment, an extension module for water sport equipment and a set consisting of water sport equipment and an extension module.

Electronic devices which are used underwater usually have a watertight housing for sealing with respect to the surrounding water. In order to enable the exchange of data and energy with other electronic devices or modules without endangering the tightness of the housing, connection interfaces of the type mentioned initially can be provided. These have the advantage that they can transmit and/or receive data and energy in wireless manner and therefore wired plug connections which necessarily assume an electrical contact can be dispensed with.

Known from US 2015/0312985 A1 is an inductive energy transmission system which in addition to the transmission of energy, also enables data communication via radio units. Disadvantageously, interference can occur during the data transmission due to an external transmitter or generally external interference sources (e.g. a motor). A reliable data transmission is therefore not always ensured which is a disadvantages particularly in safety-critical applications. Furthermore a duplex data transmission is not possible in the energy transmission system of US 2015/0312985 A1.

A similar energy transmission system is furthermore known from WO 2016/153589 A2.

GB 2554465 A discloses an interface for underwater supply lines.

WO 2019/135409 A1 discloses a device for charging an underwater drone.

WO 2012/113757 A1 discloses an underwater connector for wireless data and energy transmission.

It is the object of the present invention to reduce or even completely eliminate the disadvantages of the prior art. In particular, it is the object of the present invention to provide a connection interface of the type mentioned initially in which the data transmission is not influenced by the energy transmission.

This object is achieved by a connection interface having the features of Claim 1.

Accordingly, the object is achieved by the fact that the connection unit is designed as an optical connection unit for transmitting and/or receiving an optical signal. Optionally any influence of the data transmission by the charging coil can be avoided by using an optical connection unit and the stability and security of the data transmission can thereby be improved. As a result, the connection interface according to the invention is particularly suitable for safety-critical underwater application such as drives or control devices. The optical connection unit can be configured for transmission and/or receiving in a wavelength range between 350 nm (nanometres) and 1600 nm. In particular, an infrared connection unit (IR connection unit), in particular in a wavelength range between 780 nm and 1600 nm, can be used as optical connection unit. The connection unit can comprise both a transmitting unit and also a receiving unit. As a result, it is possible to achieve a bidirectional data transmission which can also take place at the same time (duplex transmission). However, it can also be provided that the connection unit only comprises a transmitting unit or only a receiving unit. Furthermore, it can be provided that the charging coil can also transmit data or can receive data by modulation of the electromagnetic field generated by said coil, i.e. as an additional channel in addition to the optical connection unit. Since the connection interface according to the invention enables both wireless transmission of energy and also wireless transmission of data, the connection interface can optionally be completely integrated in a housing and is therefore particularly suitable for use underwater. In this disclosure, “transmitting” is to be understood as the transmitting and/or receiving of energy and/or data. Accordingly with the charging coil, energy can be transmitted to a similar connection interface or received by this. The charging coil can be configured as a flat coil, in particular with a spiral or annular winding. By this means the installation volume of the connection interface can be kept small.

In one exemplary embodiment it is provided that the connection unit comprises a transmitting unit, in particular a transmitting diode and/or a receiving unit, in particular a receiving diode or a receiving transistor. In a further exemplary embodiment the connection unit comprises a transmitting unit and a receiving unit. As a result, a bidirectional optical data transmission can take place in which the transmission can take place independently of the receiving. The transmitting unit can be separate from the receiving unit, in particular functionally and locally separate. The transmitting diode can comprise an IR emitter, such as an infrared transmitting diode, in particular an IR-LED diode. The receiving diode can comprise an infrared receiving diode, in particular an IR phototransistor. The transmitting unit and/or the receiving unit can inter alia also be designed as SMD components (SMD, “surface mounted device”) or THT components (THT, “through hole technology”).

If the connection unit comprises a transmitting unit and a receiving unit, the charging coil can be disposed between the transmitting unit and the receiving unit. By this means the risk of cross-talk between a transmitting unit and receiving unit, i.e. a coupling of light into the respectively other channel, can be further reduced or even completely avoided. Alternatively or additionally, an optical shielding between the two optical channels, i.e. of the transmitting unit and the receiving unit, can generally be provided. Such an optical shielding can, for example, be formed by a partition between the channels, e.g. in the form of a rib between the transmitting unit and the receiving unit or in the form of a tube or tunnel in which the transmitting unit or the receiving unit is disposed. Also a tube or a tunnel can be provided in each case for the transmitting unit and the receiving unit.

In order to guide the optical signal and reduce the light scattering, the connecting unit can comprise at least one optical waveguide for conducting the optical signal. As a result, transmitting and/or receiving units can be positioned inside the connecting interface at a different possibly more favourable position when viewed from the construction technology viewpoint. Possibly the length of a free transmission path, i.e. outside optical waveguides can be reduced. In particular, it can be provided that with a first end the optical waveguide couples in and/or out the optical signal into the connection interface and with a second end is coupled to the receiving unit and/or transmitting unit and as a result guides the optical signal to the receiving unit and/or leads it away from the transmitting unit. If a transmitting unit and a receiving unit are provided, respectively one dedicated optical waveguide can be provided for the transmitting unit and the receiving unit which, as described, is coupled to the transmitting unit or the receiving unit.

In the meantime, electronic devices have also been used in sport diving. Since the connection interface can transmit data and energy in a wireless manner and without electrical contact, it is particularly suitable for use under water. Thus, in one exemplary embodiment, water sport equipment, in particular a diver propulsion vehicle comprising a housing and an energy storage device disposed in the housing is provided, wherein a connection interface according to the above explanations is provided on an outer wall of the housing, the charging coil whereof is connected to the energy storage device. The water sport equipment can supply with energy and transmit data to and/or receive data from other devices or modules which have a similar connection interface via the connection interface. The energy storage device can be configured as an electrical rechargeable battery or electrical battery. The housing can be designed to be waterproof, in particular waterproof in accordance with IP69K. The outer wall of the housing forms the outer boundary of the housing. The connection interface is optionally disposed on an inner side of the outer wall or in a recess of the outer wall. It is important here that the optical signal can pass outwards, i.e. outside the housing, during transmission from the connection unit, or during reception can pass from outside to the connection unit. For this purpose, the outer wall can have a transparent region for the wavelength range of the optical signal used at the point at which the connection interface is disposed. When the connection interface is disposed in a recess of the outer wall, a waterproof cover can be used for the connection interface or the connection interface can be potted with a plastic, for example, a resin. The cover and the plastic can in turn have a transparent region for the wavelength range of the optical signal used and be sealed with respect to the remaining outer wall. For example, an optical waveguide can also be glued into a hole in the outer wall. Or, in the case of a THT diode as a transmitting unit and/or receiving unit, the diode itself can be glued into the hole. It is important here that all the electronic components are sealed in the housing with respect to the surrounding water. Alternatively the connection interface can also be disposed on the outer side of the housing on the outer wall. In this case, the connection interface can have its own housing which is sealed with respect to the surrounding water. Naturally the water sport equipment can have a plurality of connection interfaces according to the above explanations. Thus, a plurality of devices or modules can be connected simultaneously to the water sport equipment and supplied with energy. The connected devices or modules therefore do not require an independent energy supply but can be supplied with energy by the water sport equipment. The term “water sport equipment” should not be interpreted restrictively in this case; the invention comprises a plurality of devices for (under) water applications of any kind. As examples for water sport equipment in the sense of the invention, mention may be made of mobile drives, in particular diver propulsion vehicles, as well as cameras, scuba tanks, diving jackets or lamps. Also meant however are water vehicles or parts thereof as well as boats or parts of boats, underwater drones and submarines when there is talk of “water sport equipment here”. Finally, a device that only serves to supply energy to other devices, i.e. a type of underwater battery, with a corresponding connection interface is also water sport equipment in the sense of the invention.

In order to improve the efficiency during energy transmission, the connection interface, in particular the charging coil, can be disposed substantially parallel to the outer wall. As a result of this arrangement, the quantity of magnetic flux escaping from the housing can be increased.

In one exemplary embodiment, it is provided that the housing comprises a fastening apparatus, in particular a magnetic and/or mechanical fastening apparatus, in particular a fastening rail, for temporary fastening of an extension module to the water sport equipment so that the connection interface of the water sport equipment can be connected to a connection interface of the extension module. “Can be connected” is understood in this connection to mean that data and energy transmission is possible between the connection interfaces. In this case, the optical signal must pass from one connection unit to the other and energy can be transmitted from one charging coil to the other. The fastening apparatus can comprise a latching mechanism by means of which the extension module can be locked with the fastening apparatus in a latching position. Such latching mechanisms are known from the prior art. The latching mechanism can also comprise a release element by means of which the extension module can be released from the latching position again. Alternatively or additionally the fastening apparatus can also form a part of a screw connection to the extension module. For example, the fastening apparatus, in particular the fastening rail, can comprise a fastening hole in which a screw of the extension module can be screwed in. The fastening apparatus can also comprise a permanent magnet. In particular, the connection interface of the extension module can be disposed in the latching position or in the screwed position in such a manner that the principal extension plane of the charging coil of the extension module is disposed parallel to the principal extension plane of the charging coil of the water sport equipment and the charging coils lie one above the other. Optionally any axes of symmetry of the charging coils can lie on a common imaginary line so that an optimal electromagnetic coupling takes place. As a result of this arrangement, the electromagnetic coupling of the two charging coils can be improved.

In order to extend the water sport equipment, in one embodiment an extension module for an item of water sport equipment can be provided with a module housing, wherein a module connection interface according to the above explanations is provided, wherein the charging coil of the module connection interface is adapted for supplying energy to the extension module. Since the energy supply can thus take place through the water sport equipment, the extension module need not be provided with its own energy storage device. In particular, the module connection interface can also be disposed on an outer wall of the module housing. The outer wall of the module housing in turn forms the outer boundary of the module housing. The module connection interface is disposed, for example, on an inner side of the outer wall or in a recess of the outer wall. It is important here that the optical signal from the module connection unit can pass outside, i.e. outside the housing during transmission and/or can pass from outside to the connection unit during receiving. For this purpose the outer wall can have a transparent region for the wavelength range of the optical signal used at the point at which the module connection interface is disposed. If the module connection interface is disposed in a recess of the outer wall, a waterproof cover can be used for the module connection interface or the module connection interface can be potted with a plastic, for example, a resin. It is important here again that all the electronic components in the extension module are sealed from the surrounding water. Alternatively, the module connection interface can also be disposed on the outer side of the housing on the outer wall. In this case, the module connection interface can have its own housing that is sealed with respect to the surrounding water. The module housing can in particular be designed to be waterproof in accordance with IP69K.

Optionally, a module fastening apparatus, in particular a magnetic and/or mechanical module fastening apparatus, in particular a fastening rail and/or a fastening screw, can be provided for temporary fastening to the water sport equipment so that the connection interface of the extension module can be connected (mechanically) to a connection interface of the water sport equipment. The module fastening apparatus can, for example, be connected to a fastening apparatus of the water sport equipment. In this case, it can be provided inter alia that the module fastening apparatus forms a part of a screw connection with the fastening apparatus of the water sport equipment. For example, the module fastening apparatus can comprise a screw which can be screwed into a fastening hole of the fastening apparatus of the water sport equipment. Alternatively or additionally it can also be provided that the module fastening apparatus comprises a latching element that can be locked with a latching mechanism of the fastening apparatus of the water sport equipment. The module fastening apparatus can also comprise a permanent magnet.

In one exemplary embodiment, the extension module is configured as a control device, as a lighting device and/or as a camera. For example, the water sport equipment can be a diver propulsion vehicle and the extension module can be a control device for the diver propulsion vehicle. The control device can be connected to the diver propulsion vehicle via the connection interface and, for example, control its speed. The control signals required for this can be sent to the connection interface of the diver propulsion vehicle via the connection interface of the control device. Conversely, status information such as, for example, charging state of the energy storage device or speed can be sent from the connection interface of the diver propulsion vehicle to the connection interface of the control device. The control device can also in turn comprise a radio module, in particular a Bluetooth module that can be connected to an input device which also comprises a radio module via radio. This is particularly advantageous when the water sport equipment is used under the water surface but the control of the same should take place outside the water. The control device can then, for example, pass through the water surface and enable radio contact with the input device. The data received from the input device via the radio module can be relayed by the control device via the module connection interface to the connection interface of the water sport equipment. In a further example, the water sport equipment is configured as a diver propulsion vehicle with a plurality of connection interfaces and can be connected to a plurality of extension modules, for example, in the form of a control device and a lighting device. In this example, it can also be provided that data transmission takes place between the extension modules via the water sport equipment. For example, the control device can activate the lighting device connected to the diver propulsion vehicle.

Together the water sport equipment and the extension module are designated as a set and together form a system. The set or system comprises water sport equipment and an extension module according to the above explanations, wherein in a usage state the connection interface of the water sport equipment and the module connection interface of the extension module are connected to one another in such a manner that energy transmission is possible from the connection interface of the water sport equipment to the module connection interface of the extension module and data transmission is possible between the connection interface of the water sport equipment and the module connection interface of the extension module. The water sport equipment thus supplies the extension module with (electrical) energy. The data transmission can take place from the water sport equipment to the extension module and/or from the extension module to the water sport equipment. It can also be provided that the water sport equipment comprises at least two connection interfaces, which can each be connected to an extension module. Accordingly the water sport equipment can simultaneously supply to at least two extension modules and can transmit data to these and/or receive data from these. In this case, it is also feasible that data transmission takes place between the extension modules via the water sport equipment.

In order to be able to maintain signal exchange even in murky water, in the connected state the distance between the connection interface of the water sport equipment and the connection interface of the extension module is less than 1 cm, in particular less than 0.5 mm, in particular less than 0.4 mm or less than 0.3 mm. Here the free transmission path of the optical signal between the connection interfaces is designated as distance of the connection units. The transmission path is primarily specified by the distance between the corresponding optical connection units (including any optical waveguides) of the two connection interfaces.

The invention will be explained in detail hereinafter with reference to the figures which show exemplary embodiments to which, however, the invention should not be restricted.

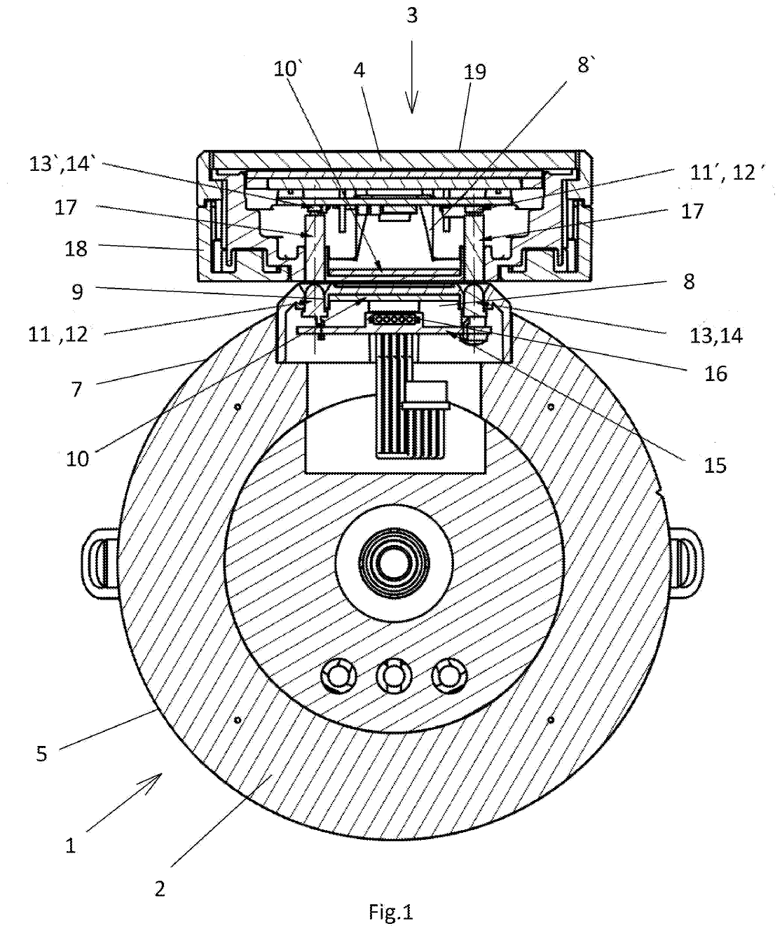

FIG. 1 shows a cross-section through water sport equipment and an extension module with respectively one connection interface.

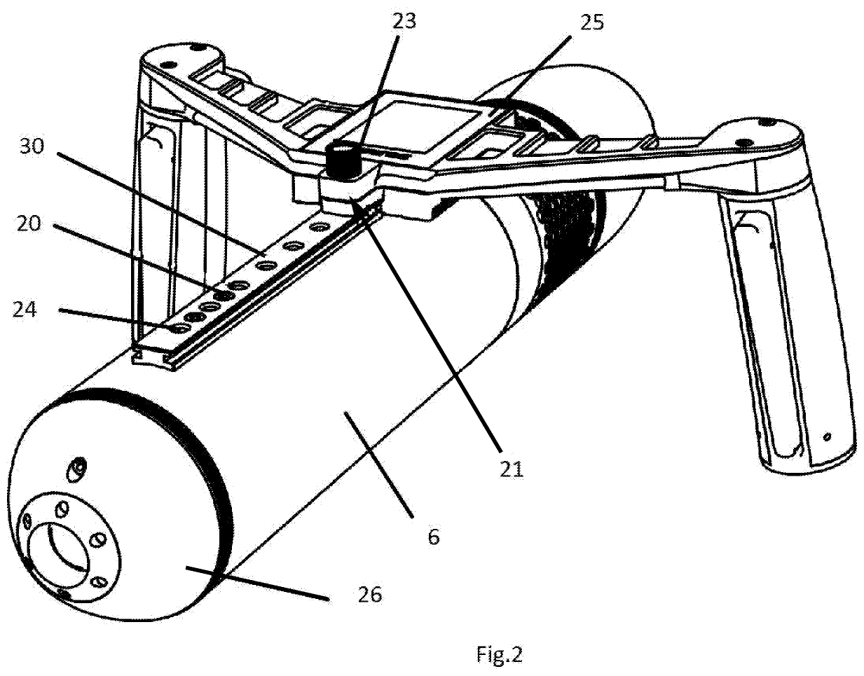

FIG. 2 shows water sport equipment in the form of a diver propulsion vehicle with two extension modules, namely a control device and a lighting device.

FIG. 1 shows a cross-section through water sport equipment 1 in the form of a diver propulsion vehicle 2 and an extension module 3 in the form of a display module 4 fastened temporarily to the water sport equipment 1. A diver propulsion vehicle 2 is an underwater drive device for a person which enables more rapid movement under water. The diver propulsion vehicle 2 has a watertight housing 5 and an energy storage device 6 disposed inside the housing 5 (see FIG. 2, accommodated in the front part of the cylindrical jacket) which serves inter alia to supply energy to a drive unit (not shown) of the diver propulsion vehicle 2. A connection interface 8 is disposed on an outer wall 7 of the housing 5. The connection interface 8 has an optical connection unit 9 for transmitting data and a charging coil 10 for transmitting electrical energy. In the embodiment shown, the optical connection unit 9 comprises a transmitting unit 11 in the form of an IR transmitting diode 12 and a receiving unit 13 in the form of an IR receiving diode 14. The charging coil 10 is disposed between the transmitting unit 11 and the receiving unit 13 to avoid signal crosstalk between the transmitting unit 11 and the receiving unit 13. The charging coil 10 is configured as a flat coil and oriented parallel to the outer wall 7. The connection unit 9 and the charging coil 10 are connected to a printed circuit board 15. Located on the printed circuit board 15 is a plug connector 16 for a flat band cable that connects the printed circuit board 15 to a main circuit board (not shown) of the diver propulsion vehicle 2, a microprocessor for controlling the charging coil 9 and communication being disposed on the main circuit board. The charging coil 10 is connected to the energy storage device 6 and transmits energy from the connection interface 8 to another similar connection interface 8′ of the extension module 3.

The connection interface of the extension module 3 designated hereinafter as module connection interface 8′ also has a transmitting unit 11′ in the form of an IR transmitting diode 12′, a receiving unit 13′ in the form of an IR receiving diode 14′ and a charging coil 10′. In the embodiment shown, the module connection interface 8′ of the extension module 3 additionally comprises two optical waveguides 17 which conduct the optical signals to the receiving unit 13′ or away from the transmitting unit 11′. It is thus possible to arrange the transmitting unit 11′ and the receiving unit 13′ at a different, possibly more favourable location when viewed from the construction technology viewpoint. In FIG. 1 it can be identified that in the module connection interface 8′ of the extension module 3 SMD diodes (SMD “surface mounted devices”) are used for the transmitting unit 11′ and the receiving unit 13′. The extension module does not have its own energy storage device but is supplied with energy from the water sport equipment 1 via the connection interfaces 8 and 8′.

The extension module 3 has a module housing 18 and a display 19 on a side facing away from the diver propulsion vehicle 2. In order to detachably connect the extension module 3 to that of the water sport equipment 1, the water sport equipment 1 can have a fastening device 20 and the extension module 3 can have a corresponding module fastening device 21 (see FIG. 2). For example, the module fastening device 21, as shown, can comprise a screw 23 which can be screwed into a fastening hole 24 of the fastening device 20 which can be configured as fastening rail 30. In FIG. 2 the diver propulsion vehicle 2 and the extension module 3 are shown in a screwed position. Alternatively or additionally the fastening device 20 can comprise a latching mechanism (not shown) by means of which the extension module 3 can be locked in a latching position with the fastening device 20. The latching position or the screwed position can be a position in which the connection interface 8 and the module connection interface 8′ lie adjacent to one another in such a manner that the charging coils 10 and 10; are arranged above one another and parallel to one another. In addition, in the latching position it can be provided that an optical signal passes from the transmitting unit 11 of the connection interface 8 of the water sport equipment 1 to the receiving unit 13′ of the module connection interface 8′ and an optical signal passes from the transmitting unit 11′ of the module connection interface 8′ to the receiving unit 13 of the connection interface 8 of the water sport equipment 1.

FIG. 2 shows a set consisting of water sport equipment 1 in the form of a diver propulsion vehicle 2 and two extension modules 3 in the form of a control device 25 and a lighting device 26. The water sport equipment 1 has two connection interfaces 8. The control device 25 can transmit control signals to one of the two connection interfaces 8 of the diver propulsion vehicle 2 via the module connection interface 8′. Conversely the corresponding connection interface 8 can transmit status data such as the charging state of the energy storage device 6 or speed of the diver propulsion vehicle 2 to the module connection interface 8′ of the control device 25. The lighting device 26 can also exchange data with the other of the two connection interfaces 8 of the diver propulsion vehicle 2 via the module connection interface 8′. In this case, it is also feasible that data can be exchanged between the lighting device 26 and the control device 25 via the diver propulsion vehicle 2, e.g. for switching on and switching off an illuminant or for adjusting the brightness, for controlling the light colour, for actuating control commands or for the status of the lighting device 26 such as the temperature of an illuminant (e.g. an LED) or error messages relating to the illuminant.

Statements relating to the connection interface 8 can, if technically appropriate, also be transmitted to the module connection interface 8′ and conversely.

1. A connection interface for underwater applications, comprising a connection unit for transmitting data and having a charging coil for inductively transmitting energy to a similar connection interface, wherein the connection unit is designed as an optical connection unit, for transmitting and/or receiving an optical signal.

2. The connection interface according to claim 1, wherein the connection unit comprises a transmitting unit, and/or a receiving unit.

3. The connection interface according to claim 2, wherein the connection unit comprises a transmitting unit and a receiving unit and the charging coil is disposed between the transmitting unit and the receiving unit.

4. The connection interface according to claim 1, wherein the connection unit comprises at least one optical waveguide for conducting the optical signal.

5. A water sport equipment, comprising a diver propulsion vehicle comprising a housing and an energy storage device disposed in the housing, wherein the connection interface according to claim 1 is provided on an outer wall of the housing, the charging coil whereof is connected to the energy storage device.

6. The water sport equipment according to claim 5, wherein the connection interface is disposed substantially parallel to the outer wall.

7. The water sport equipment according to claim 5, wherein the housing comprises a fastening apparatus, for temporary fastening of an extension module to the water sport equipment so that the connection interface of the water sport equipment can be connected to a connection interface of the extension module.

8. An extension module for a water sport equipment, comprising a module housing, wherein the connection interface according to claim 1 is provided, wherein the charging coil of the connection interface is adapted for supplying energy to the extension module.

9. The extension module according to claim 8, wherein a module fastening apparatus, is provided for temporary fastening to the water sport equipment so that the connection interface of the extension module can be connected to a connection interface of the water sport equipment.

10. The extension module according to claim 8, wherein the extension module is configured as a control device, as a lighting device and/or as a camera.

11. A set comprising the water sport equipment according to claim 5; and
an extension module, comprising a module housing provided with a module connection interface, wherein a charging coil of the module connection interface is adapted for supplying energy to the extension module;
wherein in a usage state the connection interface of the water sport equipment and the module connection interface of the extension module are connected to one another in such a manner that energy transmission is possible from the connection interface of the water sport equipment to the module connection interface of the extension module and data transmission is possible between the connection interface of the water sport equipment and the module connection interface of the extension module.

12. The set according to claim 11, wherein in the connected state the distance between the connection interface of the water sport equipment and the connection interface of the extension module is less than 1 cm.

13. The connection interface according to claim 1, wherein the connection unit is designed as an infrared connection unit for transmitting and/or receiving an optical signal.

14. The connection interface according to claim 2, wherein the connection unit comprises a transmitting diode and/or a receiving diode.

15. The water sport equipment interface according to claim 6, wherein the charging coil is disposed substantially parallel to the outer wall.

16. The water sport equipment interface according to claim 7, wherein the fastening apparatus is a mechanical and/or magnetic fastening apparatus.

17. The water sport equipment interface according to claim 7, wherein the fastening apparatus is a fastening rail.

18. The extension module according to claim 9, wherein the module fastening apparatus is a mechanical and/or magnetic module fastening apparatus.
